(19) United States
(12) Patent Application Publication
(10) Pub. No.: US 2016/0063410 A1
(43) Pub. Date: Mar. 3, 2016

(54) Systems and Methods for Task Assistance by Correlating Task Terms with Specific Entities

(71) Applicant: GOOGLE INC., Mountain View, CA (US)

(72) Inventors: Jacqueline Amy TSAY, Mountain View, CA (US); Timothy Youngjin SOHN, Mountain View, CA (US); Vijay UMAPATHY, Sunnyvale, CA (US)

(21) Appl. No.: 14/472,353

(22) Filed: Aug. 28, 2014

(51) Int. Cl. G06Q 10/06; H04W 4/04

(52) U.S. Cl. CPC G06Q 10/06312; H04W 4/04

(57) ABSTRACT

A process simplifies task management. The process receives a first task description from a user. The first task description includes a first term. The process matches the first term to a first predefined category of entities. Each entity has a physical location. The process displays multiple entities selected based on geographic proximity to a location corresponding to the user and receives user selection of a first entity. The process stores the user selection. The process later receives a second task description from the user. The second task description includes a second term, distinct from the first term. The process matches the second term to the first predefined category of entities and correlates the second task description to the first entity based on the stored user selection of the first entity for the first predefined category. The process updates information for the second task description to include the first entity.

### TECHNICAL FIELD

The disclosure relates generally to task management, and more specifically to assisting users with task management.

### BACKGROUND

Busy users have to manage many different tasks, both at work and at home. Some task management or calendaring applications allow a user to enter tasks either on a list or on a calendar. Although such an application may track all of a user's tasks in one place, the user must continue to track the list of tasks and eventually do what the task entails. Such an application does not reduce the burden on the user, and may actually increase the user's work, because the user has to enter each of the tasks, and must monitor or review what tasks need to be completed, what tasks have high priority, and so on.

### SUMMARY

Disclosed implementations address the above deficiencies and other problems associated with managing a user's tasks. When a user enters a task description, the software application may identify a keyword that represents a profession or type of business (e.g., dentist or optometrist). In some instances, the user has a relationship with a specific business entity (or other entity) for a specific profession (e.g., a specific dentist or a specific optometrist). On a one-time basis, the user is prompted to select the specific business or entity (e.g., who is your dentist). In some implementations, the user makes the selection using a map or mapping application. Once the correlation is established, the software application can identify tasks that correspond to the same category and thus link them to the same selected entity. For example, suppose the user has a specific optometrist. A future task entry to “make eye appointment” is correlated to the category “optometrist,” and thus correlated to the same optometrist, including the contact information. This simplifies the user's task. The entities in this context may be business entities, government entities, or other organizations that provide goods or services for individual people. Sometimes these entities are referred to as “local service providers.”

In accordance with some implementations, a method of simplifying task management is performed at a computing device having one or more processors and memory. The memory stores one or more programs configured for execution by the one or more processors. The method receives a first task description from a user, which includes a first term. The method matches the first term to a first predefined category of entities. Each entity has a physical location. The entities may be business entities, government entities, non-profit organizations, and so on. The method displays a plurality of entities selected based on geographic proximity of the entities to a location corresponding to the user. The method receives user selection of a first entity from the displayed plurality of entities and stores the user selection. Subsequently, the method receives a second task description from the user. The second task description includes a second term, which is distinct from the first term. The method matches the second term to the first predefined category of entities and correlates the second task description to the first entity based on the stored user selection of the first entity for the first predefined category. The method then updates information for the second task description to include the first entity.

In accordance with some implementations, each entity is pre-assigned to one or more of a set of predefined categories that include the first predefined category. In some implementations, the displayed entities are further selected based on pre-assignment to the first predefined category.

In some implementations, each entity is pre-assigned to a unique predefined category. In other implementations, at least one entity is pre-assigned to a plurality of predefined categories.

In accordance with some implementations, the first task description comprises a character string and the first term comprises a sequence of adjacent words in the character string.

In accordance with some implementations, each predefined category has a respective set of one or more lookup terms. Matching the first term to a first predefined category of entities comprises looking up the first term in an index that includes the lookup terms for each of the predefined categories, to identify the first predefined category.

In accordance with some implementations, the displayed entities are displayed on a geographic map that includes the location corresponding to the user. Each displayed entity is shown at a respective location on the geographic map corresponding to a respective physical location of the respective entity.

In accordance with some implementations, the predefined categories include one of more of dentist, doctor, optometrist, plumber, electrician, locksmith, and florist.

Thus methods and systems are provided that facilitate completion of tasks.

### BRIEF DESCRIPTION OF THE DRAWINGS

For a better understanding of the aforementioned implementations of the invention as well as additional implementations thereof, reference should be made to the Description of Implementations below, in conjunction with the following drawings in which like reference numerals refer to corresponding parts throughout the figures.

FIG. 1 illustrates a context in which some implementations operate.

FIG. 2 is a block diagram of a client computing device according to some implementations.

FIG. 3 is a block diagram of a server according to some implementations.

FIG. 4 provides an example process flow for assisting a user to complete a task in accordance with some implementations.

FIG. 5 illustrates a portion of a user interface that may be used in accordance with some implementations.

FIGS. 6A-6C provide a flowchart of a process, performed at a client computing device, for assisting users with tasks according to some implementations.

Reference will now be made in detail to implementations, examples of which are illustrated in the accompanying drawings. In the following detailed description, numerous specific details are set forth in order to provide a thorough understanding of the present invention. However, it will be apparent to one of ordinary skill in the art that the present invention may be practiced without these specific details.

### DESCRIPTION OF IMPLEMENTATIONS

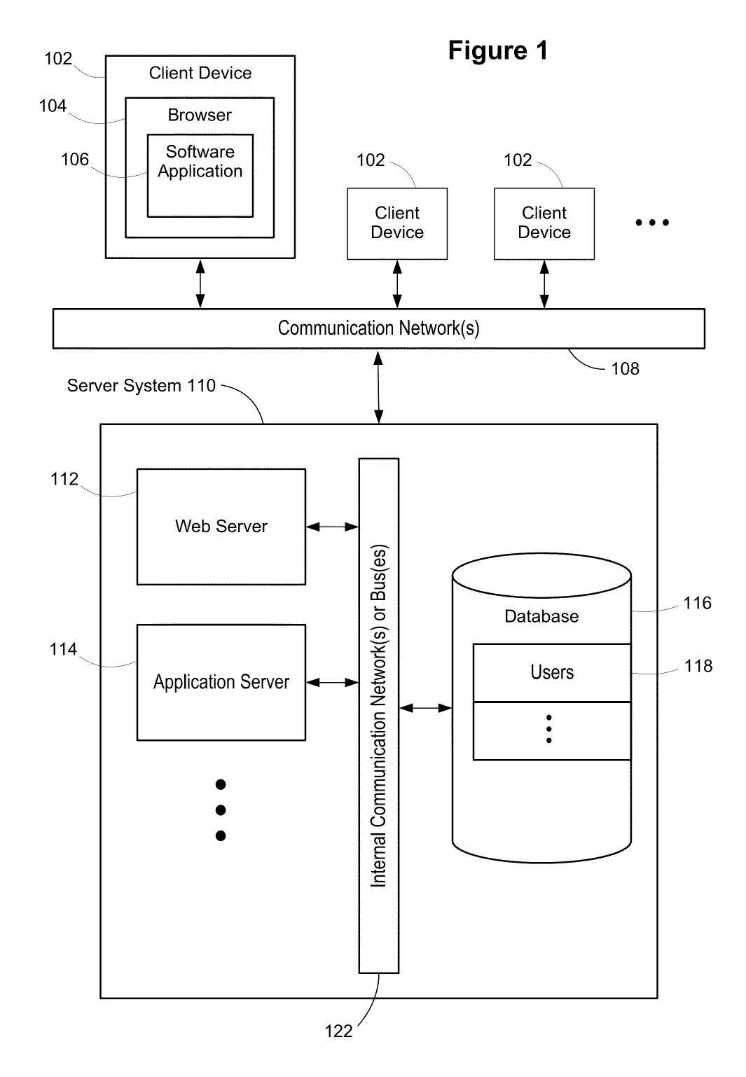

FIG. 1 is a block diagram that illustrates the major components of some implementations. The various client devices 102 (also identified herein as computing devices) and servers 300 in a server system 110 communicate over one or more networks 108 (such as the Internet). A client device 102 may be a smart phone, a tablet computer, a laptop computer, a desktop computer, or other computing device that has access to a communication network 108 and can run a software application 106 (e.g., a task management application or a messaging application). In some implementations, the software application 106 runs within a web browser 104.

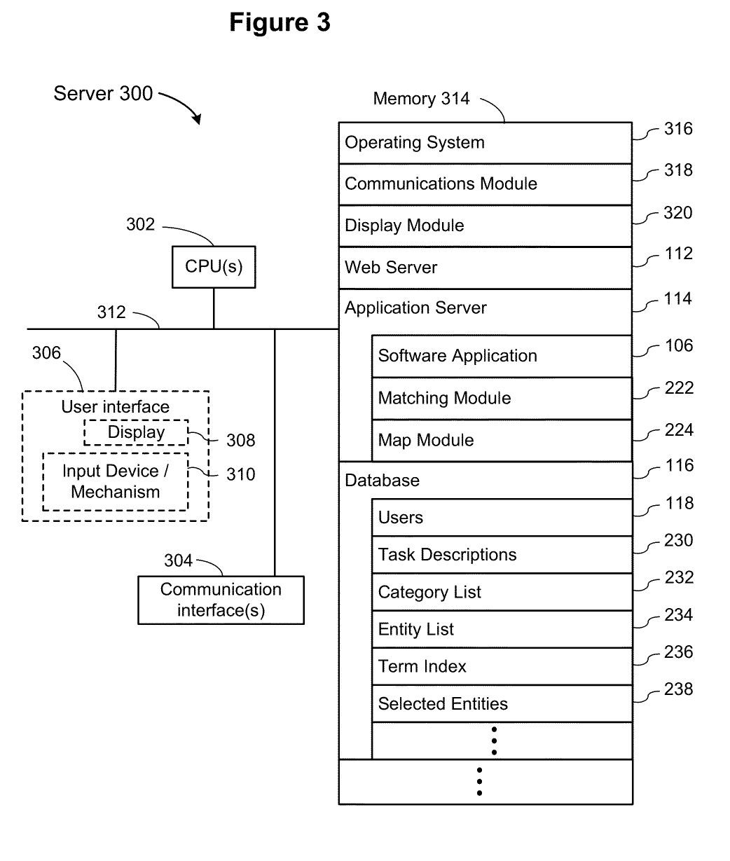

In some implementations, the server system 110 consists of a single server 300. In other implementations, the server system 110 includes a plurality of servers 300. In some implementations, the servers 300 are connected by an internal communication network or bus 122. The server system 110 includes one or more web servers 112, which receive requests from users (e.g., from client devices 102) and return appropriate information, resources, links, and so on. In some implementations, the server system 110 includes one or more application servers 114, which provide various applications, such as a messaging application or task management application (e.g., software application 106). The server system 110 typically includes one or more databases 116, which store information such as web pages, a user list 118, and various other information (e.g., user specific information, such as user names and encrypted passwords, user preferences, and so on, as well as system level information, as illustrated below in FIG. 3).

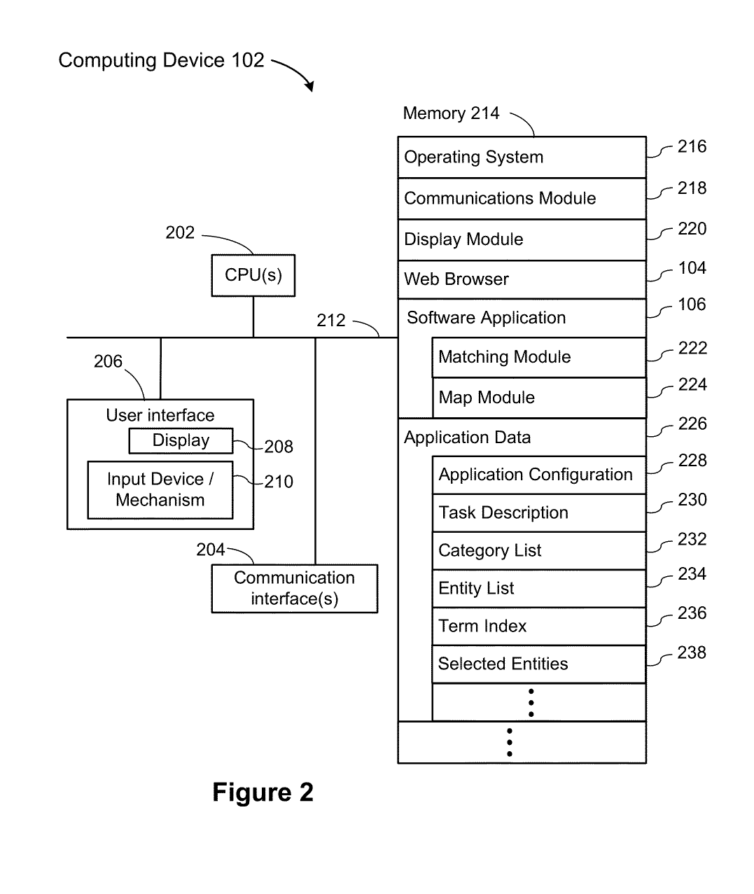

FIG. 2 is a block diagram illustrating a client device 102 that a user uses to access a software application 106. A client device is also referred to as a computing device, which may be a tablet computer, a laptop computer, a smart phone, a desktop computer, a PDA, or other computing device than can run a software application 106 and has access to a communication network 108. A client device 102 typically includes one or more processing units (CPUs) 202 for executing modules, programs, or instructions stored in the memory 214 and thereby performing processing operations; one or more network or other communications interfaces 204; memory 214; and one or more communication buses 212 for interconnecting these components. The communication buses 212 may include circuitry (sometimes called a chipset) that interconnects and controls communications between system components. A client device 102 includes a user interface 206 comprising a display device 208 and one or more input devices or mechanisms 210. In some implementations, the input device/mechanism includes a keyboard and a mouse; in some implementations, the input device/mechanism includes a “soft” keyboard, which is displayed as needed on the display device 208, enabling a user to “press keys” that appear on the display 208.

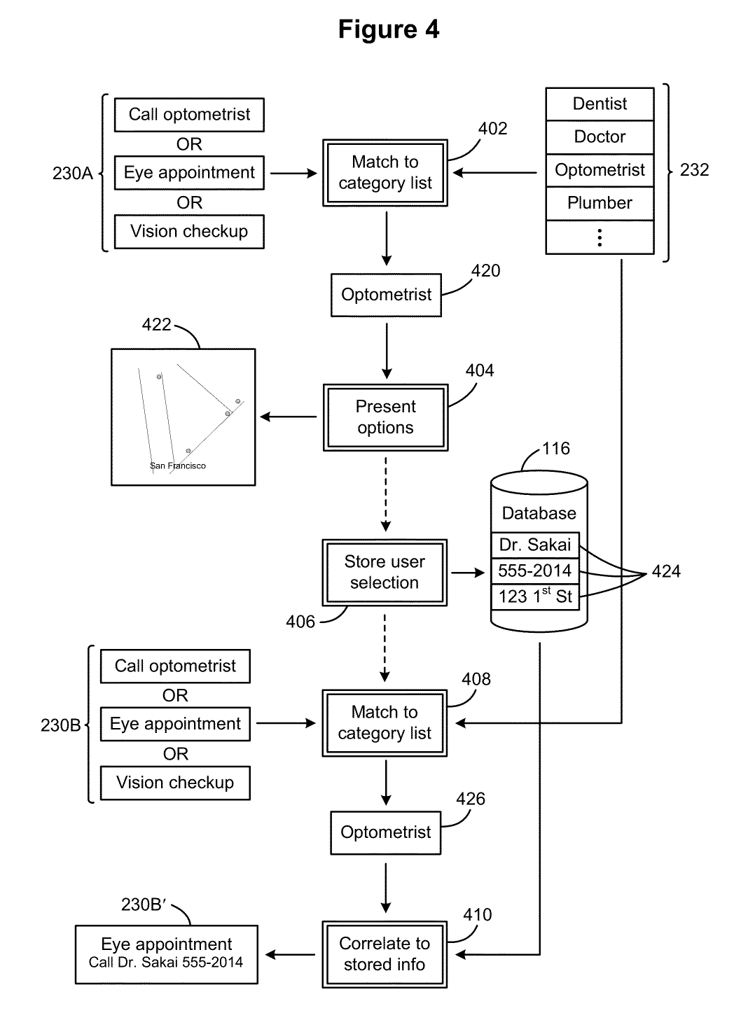

In some implementations, the memory 214 includes high-speed random access memory, such as DRAM, SRAM, DDR RAM or other random access solid state memory devices. In some implementations, the memory 214 includes non-volatile memory, such as one or more magnetic disk storage devices, optical disk storage devices, flash memory devices, or other non-volatile solid state storage devices. In some implementations, the memory 214 includes one or more storage devices remotely located from the CPU(s) 202. The memory 214, or alternately the non-volatile memory device(s) within the memory 214, comprises a non-transitory computer readable storage medium. In some implementations, the memory 214, or the computer readable storage medium of the memory 214, stores the following programs, modules, and data structures, or a subset thereof:
an operating system 216, which includes procedures for handling various basic system services and for performing hardware dependent tasks;
a communications module 218, which is used for connecting the client device 102 to other computers and devices via the one or more communication network interfaces 204 (wired or wireless) and one or more communication networks 108, such as the Internet, other wide area networks, local area networks, metropolitan area networks, and so on;
a display module 220, which receives input from the one or more input devices 210, and generates user interface elements for display on the display device 208;
a web browser 104, which enables a user to communicate over a network 108 (such as the Internet) with remote computers or devices;
a software application 106, such as a messaging application or a task management application. In some implementations, the software application 106 runs within the web browser 104 as illustrated in FIG. 1. In some implementations, the software application 106 runs independently of a web browser 104 (e.g., a desktop application). In some implementations, the software application includes a matching module 222, which matches a term (e.g., a sequence of one or more words) from a user-entered task description 230 to a stored set of entity categories 232. Entity categories typically identify types of businesses. This is illustrated below in FIG. 4. In some implementations, the software application 106 includes a map module 224. The map module 224 displays a map that includes entities (e.g., local service providers) near the user. This is illustrated below in FIG. 4;
application data 226, which is used by the software application 106. In some implementations, the application data 226 includes configuration data 228, which identifies how the software application is configured for a particular computing device 102. For example, the configuration data may specify which entity categories 232 are active, whether task assistance is turned on or off, as well as user interface customizations. When a user enters a task description 230, it is stored. In some implementations, the application data 226 is stored in a relational database, a CSV file, or an XML file.

In some implementations, the application data 226 at the client device 102 includes a category list 232. Each category identifies a type of entity that provides goods or services to users/customers. For example, in some implementations the categories include one or more of dentist, doctor, optometrist, plumber, electrician, locksmith, and florist. In some implementations, categories include government entities as well, such as police or DMV. In some implementations, the entity categories include non-profit organizations as well as social organizations and clubs (e.g., a PTA). In some implementations, the entities are limited to those that have a physical location. In some implementations, the entities are limited to those that have some form of contact information (e.g., a phone number or web address). In some implementations, a user may choose which entities are active.

Each category in the category list typically has an associated name (e.g., “dentist”) as well as other data, such as keywords associated with the category (e.g., “dental,” “teeth,” and “root canal”). In some implementations, the associated keywords are saved in a term index 236, as described below.

In some implementations, the application data 226 at the client device 102 includes an entity list 234. Each record in the entity list 234 identifies a specific business entity (e.g., “Joe's Barber Shop” in a specific city), a specific government entity (e.g., a DMV office in a specific city), or other organization (e.g., a specific rotary club in a specific city). Each record also includes other information about the entity, such as a phone number, a physical address, an email address, a web address, and so on. In some implementations, each entity is pre-assigned to one or more of the entity categories in the category list 232. In some implementations, each entity is assigned to a unique category. In some implementations, an entity may be assigned to multiple categories. In some implementations that enable assignment to multiple categories, each entity is assigned to a unique primary category.

In some implementations, the application data 226 at a client device 102 includes a term index 236 or other data structure to identify a category corresponding to specific terms. In some implementations, terms associated with each of the categories are included in a term index 236, enabling quick identification of a category corresponding to terms that have been entered. As used herein, a “term” may be a single word or multiple adjacent words that constitute a logical unit. For example, “root canal” is one term that is associated with the category “dentist.” Some implementations have more complex matching algorithms, and thus store alternative data structures to support those algorithms.

In some implementations, the application data 226 for a client device 102 includes data 238 that specifies what entities a user has selected for various entity categories. Some implementations use a selected entities table 238. In some implementations, each record in the selected entities table 238 includes a user identifier (e.g., a unique user ID), a category identifier (e.g., a category name), and an entity identifier (e.g., a unique identifier for an entity).

In some implementations, one or more of the category list 232, the entity list 234, the term index 236, and the selected entities data 238 are stored at a server system 110 instead of, or in addition to, at the client device 102.

Each of the above identified executable modules, applications, or sets of procedures may be stored in one or more of the previously mentioned memory devices and corresponds to a set of instructions for performing a function described above. The above identified modules or programs (i.e., sets of instructions) need not be implemented as separate software programs, procedures, or modules, and thus various subsets of these modules may be combined or otherwise re-arranged in various implementations. In some implementations, the memory 214 may store a subset of the modules and data structures identified above. Furthermore, the memory 214 may store additional modules or data structures not described above.

Although FIG. 2 shows a client device 102, FIG. 2 is intended more as a functional description of the various features that may be present rather than as a structural schematic of the implementations described herein. In practice, and as recognized by those of ordinary skill in the art, items shown separately could be combined and some items could be separated.

FIG. 3 is a block diagram illustrating a server 300 that may be used in a server system 110. A typical server system includes many individual servers 300, which may be tens, hundreds, or thousands. A server 300 typically includes one or more processing units (CPUs) 302 for executing modules, programs, or instructions stored in the memory 314 and thereby performing processing operations; one or more network or other communications interfaces 304; memory 314; and one or more communication buses 312 for interconnecting these components. The communication buses 312 may include circuitry (sometimes called a chipset) that interconnects and controls communications between system components. In some implementations, a server 300 includes a user interface 306, which may include a display device 308 and one or more input devices 310, such as a keyboard and a mouse.

In some implementations, the memory 314 includes high-speed random access memory, such as DRAM, SRAM, DDR RAM or other random access solid state memory devices. In some implementations, the memory 314 includes non-volatile memory, such as one or more magnetic disk storage devices, optical disk storage devices, flash memory devices, or other non-volatile solid state storage devices. In some implementations, the memory 314 includes one or more storage devices remotely located from the CPU(s) 302. The memory 314, or alternately the non-volatile memory device(s) within the memory 314, comprises a non-transitory computer readable storage medium. In some implementations, the memory 314, or the computer readable storage medium of the memory 314, stores the following programs, modules, and data structures, or a subset thereof:
an operating system 316, which includes procedures for handling various basic system services and for performing hardware dependent tasks;
a communications module 318, which is used for connecting the server 300 to other computers via the one or more communication network interfaces 304 (wired or wireless), an internal network or bus 122, and communication networks 108, such as the Internet, other wide area networks, local area networks, metropolitan area networks, and so on;
a display module 320, which receives input from one or more input devices 310, and generates user interface elements for display on a display device 308;
one or more web servers 112, which receive requests from a client device 102, and return responsive web pages, resources, or links. In some implementations, each request is logged in the database 116;
one or more application servers 114, which provide various software applications 106 (such as an email or other messaging application) to the client devices 102. In some implementations, an application is provided as a set of web pages, which are delivered to the client devices 102 and displayed in a web browser 104. The web pages are delivered as needed or requested. In some implementations, an application is delivered to a client device 102 as a download, which is installed and run from the client device 102 outside of a web browser 104. In some implementations, the application server provides a matching module 222 as part of the software application 106. In other implementations, the matching module 222 is a separate application provided by the application server 114. As illustrated in FIG. 4, the matching module 222 matches a term from a user-entered task description 230 against a category list 232. In some implementations, the application server 114 provides a map module 224, which may be a separate application or an integrated part of the matching module 222 or the software application 106. The map module 224 is described with respect to FIGS. 2 and 4;
one or more databases 116, which store various data used by the modules or programs identified above. In some implementations, the database 116 includes a list of authorized users 118, which may include user names, encrypted passwords, and other relevant information about each user. In some implementations, the database 116 stores task descriptions 230. In some implementations, the database 116 stores a category list 232, an entity list 234, a term index 236, and selected entities data 238, which are described above with respect to FIG. 2.

Each of the above identified elements in FIG. 3 may be stored in one or more of the previously mentioned memory devices. Each executable program, module, or procedure corresponds to a set of instructions for performing a function described above. The above identified modules or programs (i.e., sets of instructions) need not be implemented as separate software programs, procedures or modules, and thus various subsets of these modules may be combined or otherwise re-arranged in various implementations. In some implementations, the memory 314 may store a subset of the modules and data structures identified above. Furthermore, the memory 314 may store additional modules or data structures not described above.

Although FIG. 3 illustrates a server 300, FIG. 3 is intended more as functional illustration of the various features that may be present in a set of one or more servers rather than as a structural schematic of the implementations described herein. In practice, and as recognized by those of ordinary skill in the art, items shown separately could be combined and some items could be separated. The actual number of servers used to implement these features, and how features are allocated among them, will vary from one implementation to another, and may depend in part on the amount of data traffic that the system must handle during peak usage periods as well as during average usage periods.

As illustrated in FIGS. 2 and 3, the functionality for a software application 106 may be shared between a client device 102 and a server system 110. In some implementations, after the software application is installed on a client device 102, the majority of the subsequent processing occurs on the client device. For example, all of the application data 226 may be stored at the client device and used directly by the client device. In other implementations, the majority of the processing and data storage occurs at a server 300, and the client device 102 uses a web browser 104 to view and interact with the data. For example, the category list 232, the entity list 234, and the term index 236 may be stored only at the server system 110. One of skill in the art recognizes that various allocations of functionality between the client device 102 and the server system 110 are possible, and some implementations support multiple configurations (e.g., based on user selection).

FIG. 4 illustrates a process flow for a specific example of assisting a user with task management. A user provides a task description 230A, such as “Call optometrist,” “Eye appointment,” or “Vision checkup.” In some implementations, the task description 230A is entered into a task management application or a messaging application (e.g., in a messaging application calendar). In some implementations, the software application 106 provides possible completions to the task description as it is entered.

The matching module 222 compares (402) one or more terms from the task description 230A to a category list 232. Here, the terms “optometrist,” “eye,” and “vision” may be matched to the “optometrist” category, whereas the terms “call,” “appointment,” and “checkup” would not match a category. In some implementations, the matching module 222 looks up the terms from a task description in a term index 236 to identify a matching category.

Once the matching category “optometrist” 420 is identified, the map module 224 presents (404) options so that the user can select the appropriate entity. In some implementations, the entities are pre-assigned to categories, and thus only the relevant entities are displayed on the map 422. In other implementations, the entities are not pre-assigned, and thus the map 422 displays a greater number of options. In some implementations, the map is interactive, and thus the user can zoom in/out or scroll the map portion that is displayed. In some implementations, the map is initially displayed based on a location associated with the user. For example, a user whose home address is in San Francisco may see a map showing a portion of San Francisco, as illustrated in the map 422. In some implementations, the map is based on an alternative location, such as the user's current geographic location (e.g., as determined by GPS). Some implementations provide an interface other than a map, which may be used instead of or in addition to the map interface. For example, some implementations provide a scrollable list of entities corresponding to the category, which may be sorted alphabetically or based on distance from the user location. Some implementations provide an entry box so that the user can enter the name of the appropriate entity. In some implementations that enable a user to key in the name of the desired entity, the user interface provides completion options as the user types, which may be updated after each keystroke.

If the user selects one of the entity options presented, the software application stores (406) the user selection (e.g., in the application data 226 at the client device or in the database 116 at the server system 110). In some implementations, the relevant information from the entities list 234 is copied to the selected entities data 238. This stored information 424 may include the name of the entity or the name of a person working for the entity, a phone number of the entity, a physical address for the entity, a web address for the entity, or an email address for the entity. In some implementations, rather than copying the entity data, the selected entities table 238 stores an entity identifier, which is the unique identifier for the entity in the entity list (e.g., the primary key of the entity table). If the entity table is maintained centrally, using a link also has the advantage of always pointing to the current information.

At some point in the future, the same user enters another task description 230B. In this example, suppose that the entered task description is “eye appointment,” and that this is not the same as the first task description 230A. The matching module 222 compares (408) the task description 230B to the category list 232, and identifies “optometrist” 426 as the corresponding category.

This time, however, the software application looks up the stored data 424 and finds that the user has previous selected an optometrist, and thus correlates (410) the new optometry task to the user's saved optometrist information. The software application 106 then updates the user interface with the relevant information, which simplifies the task of making an eye appointment by providing an annotated task description 230B′. In some implementations, the annotations are added to the task description. In some implementations, the annotations are stored separately from the task description.

Once the user correlates a specific entity with a category one time, all future task entries can take advantage of the saved information. For example, a user does not go to a dentist or optometrist frequently, and thus is unlikely to remember the phone number or web address. In some instances, a user may not even remember the name of the entity when it is time to make another appointment a year later, and thus it could be difficult to even look up the relevant entity. Because disclosed implementations match based on various descriptive terms (e.g., “eye appointment”), the user is not burdened with remembering details about the entity.

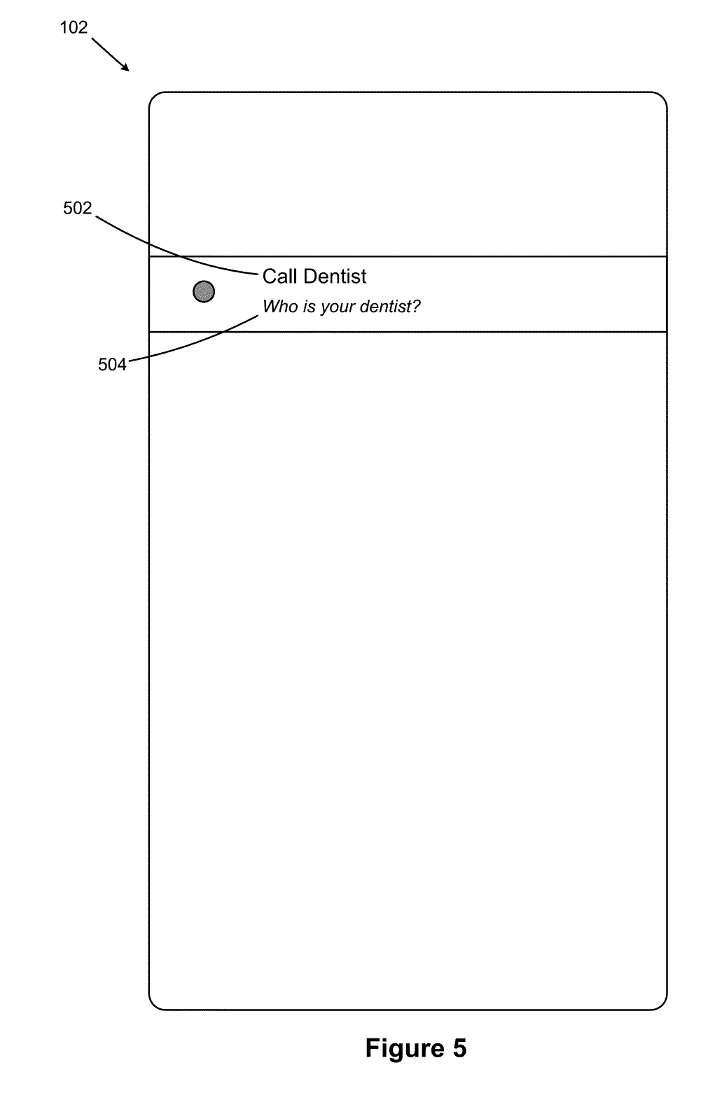

FIG. 5 provides a skeletal user interface for some implementations. The user interface is displayed on a computing device 102, which is a smart phone here. The user has entered a task description to “Call dentist” 502, and the software application 106 has identified the key term “dentist.” In this example, the user has not previously identified a dentist, so the user interface prompts the user with the message “Who is your dentist?” 504. In some implementations, the message 504 is an active link, and selecting the link (e.g., using a touch gesture) brings up the interface to select a dentist (similar to the map 422 in FIG. 4). Other implementations provide various user interface controls for selecting an entity (e.g., a dentist). For example, some implementations provide a drop down control and a map icon adjacent to the message 504, allowing a user to select from a list or to open a map for selection.

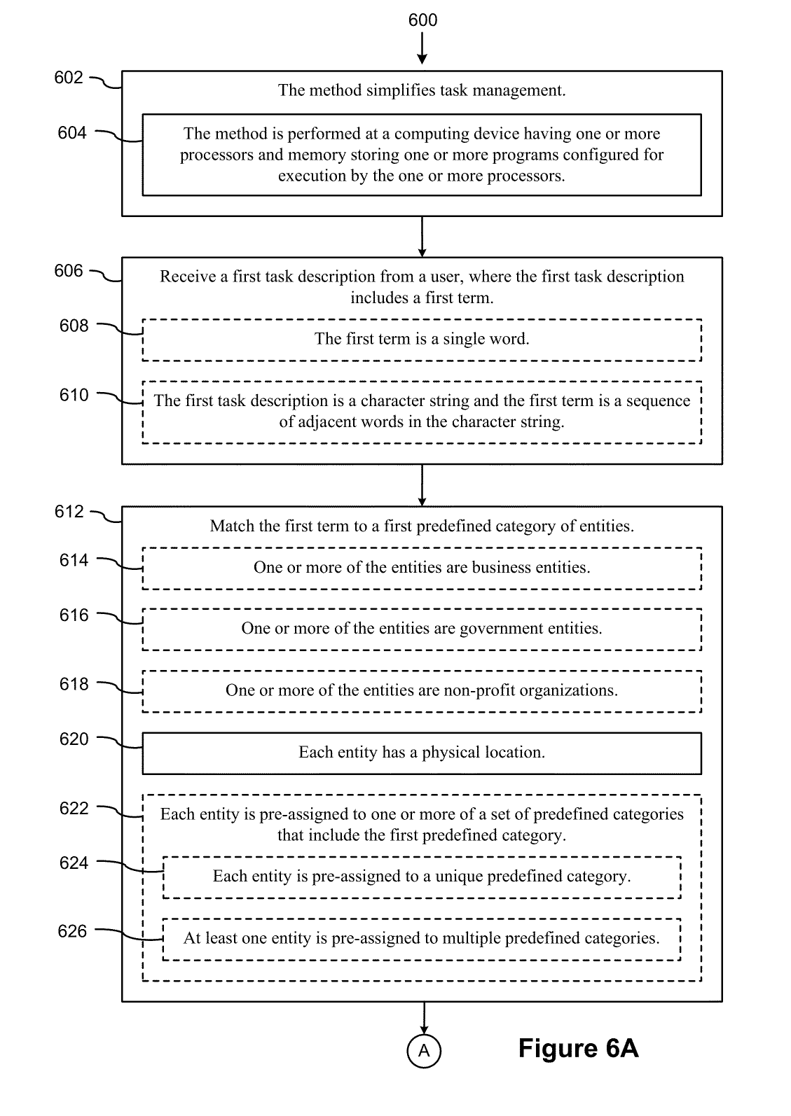

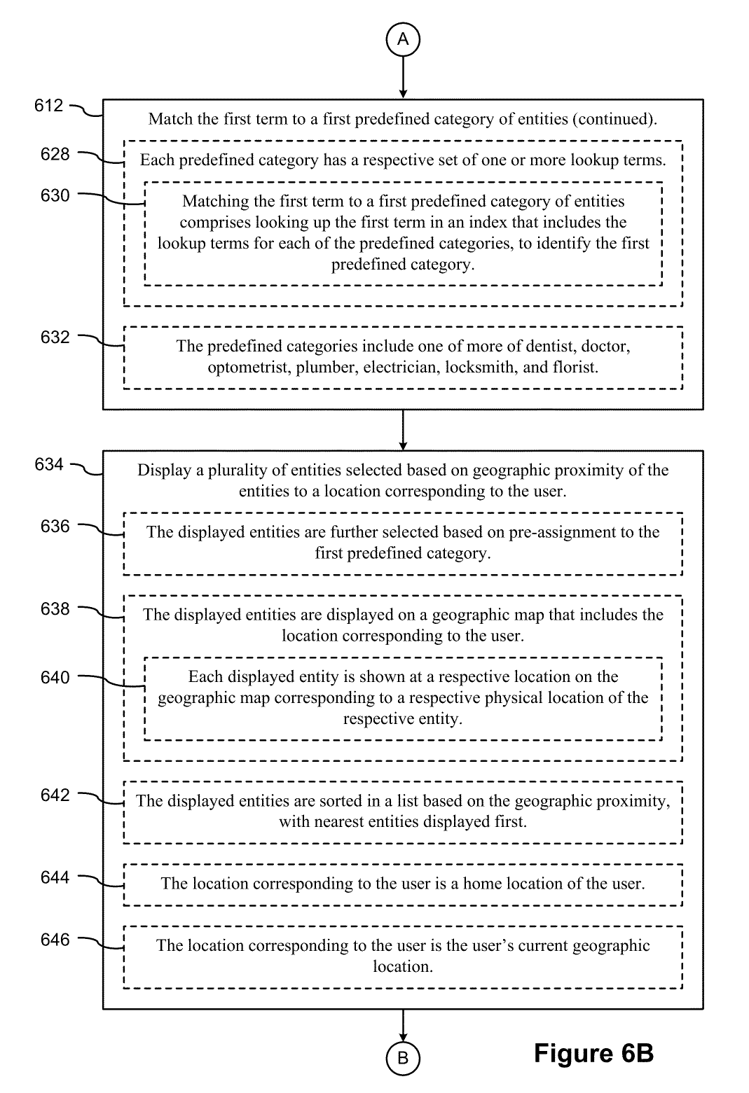

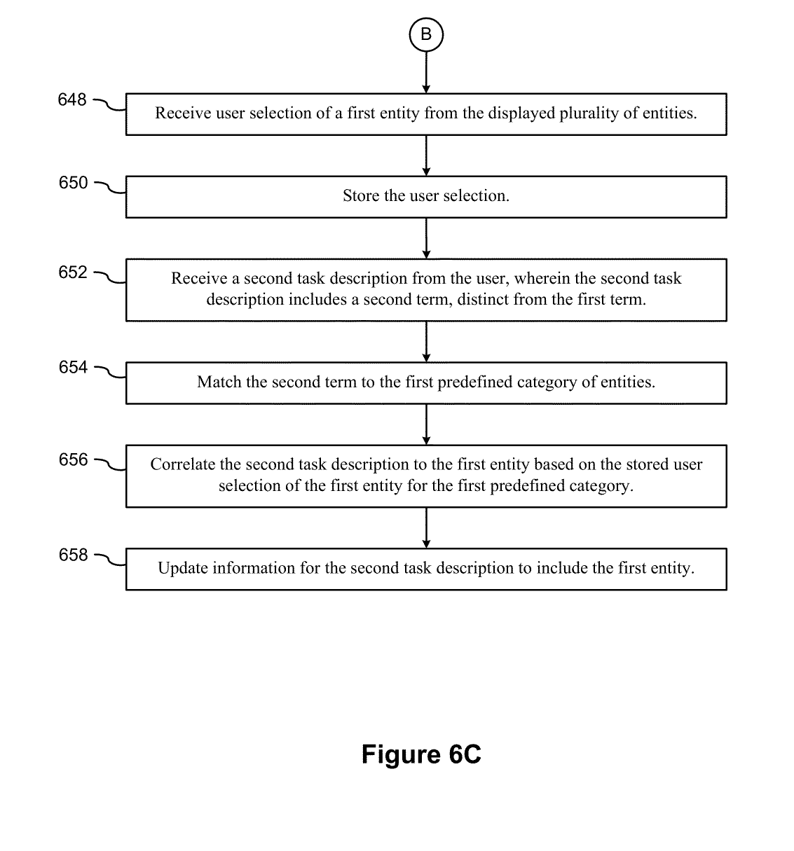

FIGS. 6A-6C provide a flowchart of a process 600, performed by a computing device 102, for simplifying (602) task management. The method is performed (604) at a computing device 102 having one or more processors and memory. The memory stores (604) one or more programs configured for execution by the one or more processors. In some implementations, the one or more programs comprise a task management application. In some implementations, the one or more programs comprise a messaging application. For example, the one or more programs may implement calendaring or scheduling functionality within the messaging application.

A user enters a task description 230, which is received (606) by the software application 106. In some implementations, the task description 230 is a character string, such as “call optometrist” 230A in FIG. 4. In some implementations, the character string is constructed solely from user input (i.e., the user enters each of the characters). In other implementations, the software application 106 identifies completions to the task description based on what the user has already entered, enabling the user to enter the description more quickly and/or more accurately. Some implementations provide partial completions (e.g., an individual word rather than an entire task description). In some implementations, some of the completions (or partial completions) are based on the category names in the category list 232. This can result in more structured task descriptions, and may simplify the matching process 402 later.

The task description 230 includes (606) a first term. In some instances, the first term is (608) a single word, such as the word “eye” or the word “vision” as illustrated by the task descriptions 230A in FIG. 4. In some instances, the first term itself is the name of a category, such as the term “optometrist” in FIG. 4. In some instances, the first term is (610) a sequence of adjacent words in the task description character string. For example, “root canal” is a term that may be matched to the “dentist” category.

The process 600 matches (612) the first term to a first predefined category of entities. In some implementations, one or more of the entities are (614) business entities (e.g., companies selling goods or services to people). In some implementations, one or more of the entities are (616) government entities (e.g., government entities that provide services to people). In some implementations, one or more of the entities are (618) non-profit organizations, social organizations, or clubs. In some cases, all of these entities are referred to as “service providers.” Some implementations focus on entities that are geographically near the user, and thus the entities are referred to as “local service providers.” For example, a person typically goes to a dentist or optometrist near when the user lives.

Typically, each entity has (620) a physical location, although some implementations support other entities, as long as they have some contact information (e.g., a phone number, email address, or website).

In some implementations, each entity is pre-assigned (622) to one or more of a set of predefined categories that include the first predefined category. Pre-assigned categories can be very helpful to users, because once the appropriate category is identified, the data subsequently presented to the user can be filtered to the relevant entities (e.g., if a user is looking up a dentist, the user sees only dentists, not retail stores, plumbers, restaurants, etc. In some implementations, each entity is pre-assigned (624) to a unique predefined category. In other implementations, some of the entities are pre-assigned (626) to multiple predefined categories.

In some implementations, each predefined category has (628) a respective set of one or more lookup terms. For example, the category “dentist” may have the lookup terms “dentist,” “teeth,” and “root canal.” Note that “teeth” could be ambiguous if “orthodontia” were another of the predefined categories. In some implementations, matching the first term to a first predefined category of entities includes (630) looking up the first term in an term index 236 that includes the lookup terms for each of the predefined categories. The lookup identifies (630) the first predefined category.

Different implementations use various sets of entity categories. In some implementations, the predefined categories include (632) one or more of dentist, doctor, optometrist, plumber, electrician, locksmith, and florist. In some implementations, the categories used are based on experimental data regarding what types of entities have ongoing relationships with their customers. For example, a user is likely to return to the same dentist or optometrist, but may not necessarily go back to the same florist.

The user interface then prompts the user to select a specific entity corresponding to the identified category. The user interface displays (634) multiple entities that are selected (634) based on geographic proximity to a location corresponding to the user. This is illustrated above in FIG. 4 using the map interface 422. In some implementations, the displayed entities are further selected (636) based on pre-assignment of the entities to the first predefined category. In some implementations, the displayed entities are displayed (638) on a geographic map that includes the location corresponding to the user (as illustrated by the map 422 in FIG. 4). In these implementations, each displayed entity is shown (640) at a respective location on the geographic map corresponding to a respective physical location of the respective entity. In some implementations, the location corresponding to the user is (644) a home location of the user. In some implementations, the location corresponding to the user is (646) the user's current geographic location (e.g., determined by GPS from a mobile device).

In some implementations, the displayed entities are sorted (642) in a list based on the geographic proximity, with nearest entities displayed first. Some implementations display a sorted list instead of a map interface. Some implementations display both a sorted list and a map interface, or enable a user to choose the selection methodology.

The user selects (648) a first entity from the displayed multiple entities, and the user selection is stored (650). This is illustrated above in FIG. 4.

Subsequently, the user enters (652) a second task description 230. The second task description includes (652) a second term, which is distinct from the first term. Like the first term, the second term may be a single word of a sequence of words. The matching module 222 matches (654) the second term to the first predefined category of entities. Based on this matching, the software application correlates (656) the second task description to the first entity. The correlation uses (656) the stored user selection of the first entity for the first predefined category. The software application then updates (658) information for the second task description to include the first entity (e.g., information about the first entity). This is illustrated by the annotated task message 230B′ in FIG. 4.

Some implementations extend the described process in various ways. For example, whereas a user may have a single dentist or a single optometrist, a user may have multiple doctors or multiple relationships with other categories of business. Therefore, some implementations allow a user to store these multiple relationships for the same entity category. Implementations typically limit the categories to ones where a user uses a single entity or a small number of entities. For these categories, the user selected entities (local service providers) simplify task management. Some implementations support other categories as well, such as “restaurants,” where a user may designate many entities corresponding to the category. In the restaurant example, the list acts more like a list of favorites.

Some implementations extend the described process to entities that are not physically close to the user and/or have no user-accessible physical location. For example, a user may do banking through an Internet-only bank, or have a life insurance carrier that is out of state. Some implementations provide a user interface to look up entities by name or using a functional hierarchy to find the right one. Some implementations allow a user to enter the data for an entity manually. For example, a user may enter a phone number or web address for an Internet bank, and a subsequent task description to “call the bank” would be associated with the bank data entered. Some implementations provide a map user interface to easily identify local service providers, with an option to enter data manually when the appropriate entity is not on the map.

Some implementations enable a user to associate an entity with a label that is not matched to a predefined category. The label acts like an alias or a custom category for the designated entity, and allows the user to identify an entity within a task description in a concise way.

Some implementations enable a user to associate a specific local service provider with a category while creating a task description. For example, a user may select directly from the set of categories and then associate the category with a local service provider.

The terminology used in the description of the invention herein is for the purpose of describing particular implementations only and is not intended to be limiting of the invention. As used in the description of the invention and the appended claims, the singular forms “a,” “an,” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “comprises” and/or “comprising,” when used in this specification, specify the presence of stated features, steps, operations, elements, and/or components, but do not preclude the presence or addition of one or more other features, steps, operations, elements, components, and/or groups thereof.

The foregoing description, for purpose of explanation, has been described with reference to specific implementations. However, the illustrative discussions above are not intended to be exhaustive or to limit the invention to the precise forms disclosed. Many modifications and variations are possible in view of the above teachings. The implementations described herein were chosen and described in order to best explain the principles of the invention and its practical applications, to thereby enable others skilled in the art to best utilize the invention and various implementations with various modifications as are suited to the particular use contemplated.

What is claimed is:

1. A method of simplifying task management, comprising:
at a computing device having one or more processors and memory storing one or more programs configured for execution by the one or more processors:
receiving a first task description from a user, wherein the first task description includes a first term;
matching the first term to a first predefined category of entities, wherein each entity has a physical location;
displaying a plurality of entities selected based on geographic proximity of the entities to a location corresponding to the user;
receiving user selection of a first entity from the displayed plurality of entities and storing the user selection;
receiving a second task description from the user, wherein the second task description includes a second term, distinct from the first term;
matching the second term to the first predefined category of entities;
correlating the second task description to the first entity based on the stored user selection of the first entity for the first predefined category; and
updating information for the second task description to include the first entity.

2. The method of claim 1, wherein one or more of the entities are business entities.

3. The method of claim 1, wherein one or more of the entities are government entities.

4. The method of claim 1, wherein one or more of the entities are non-profit organizations.

5. The method of claim 1, wherein each entity is pre-assigned to one or more of a set of predefined categories that include the first predefined category.

6. The method of claim 5, wherein the displayed entities are further selected based on pre-assignment to the first predefined category.

7. The method of claim 5, wherein each entity is pre-assigned to a unique predefined category.

8. The method of claim 5, wherein at least one entity is pre-assigned to a plurality of predefined categories.

9. The method of claim 1, wherein the first term comprises a single word.

10. The method of claim 1, wherein the first task description comprises a character string and the first term comprises a sequence of adjacent words in the character string.

11. The method of claim 1, wherein each predefined category has a respective set of one or more lookup terms, and wherein matching the first term to a first predefined category of entities comprises looking up the first term in an index that includes the lookup terms for each of the predefined categories, to identify the first predefined category.

12. The method of claim 1, wherein the displayed entities are displayed on a geographic map that includes the location corresponding to the user, and wherein each displayed entity is shown at a respective location on the geographic map corresponding to a respective physical location of the respective entity.

13. The method of claim 1, wherein the displayed entities are sorted in a list based on the geographic proximity, with nearest entities displayed first.

14. The method of claim 1, wherein the location corresponding to the user is a home location of the user.

15. The method of claim 1, wherein the location corresponding to the user is the user's current geographic location.

16. The method of claim 1, wherein the predefined categories include one of more of dentist, doctor, optometrist, plumber, electrician, locksmith, and florist.

17. A computing device, comprising:
one or more processors;
memory; and
one or more programs stored in the memory configured for execution by the one or more processors, the one or more programs comprising instructions for:
receiving a first task description from a user, wherein the first task description includes a first term;
matching the first term to a first predefined category of entities, wherein each entity has a physical location;
displaying a plurality of entities selected based on geographic proximity of the entities to a location corresponding to the user;
receiving user selection of a first entity from the displayed plurality of entities and storing the user selection;
receiving a second task description from the user, wherein the second task description includes a second term, distinct from the first term;
matching the second term to the first predefined category of entities;
correlating the second task description to the first entity based on the stored user selection of the first entity for the first predefined category; and
updating information for the second task description to include the first entity.

18. The computing device of claim 17, wherein each entity is pre-assigned to one or more of a set of predefined categories that include the first predefined category.

19. The computing device of claim 18, wherein the displayed entities are further selected based on pre-assignment to the first predefined category.

20. A non-transitory computer readable storage medium storing one or more programs configured for execution by a computing device having one or more processors and memory, the one or more programs comprising instructions for:
receiving a first task description from a user, wherein the first task description includes a first term;
matching the first term to a first predefined category of entities, wherein each entity has a physical location;
displaying a plurality of entities selected based on geographic proximity of the entities to a location corresponding to the user;
receiving user selection of a first entity from the displayed plurality of entities and storing the user selection;
receiving a second task description from the user, wherein the second task description includes a second term, distinct from the first term;
matching the second term to the first predefined category of entities;
correlating the second task description to the first entity based on the stored user selection of the first entity for the first predefined category; and
updating information for the second task description to include the first entity.
